(19) United States
(12) Patent Application Publication
(10) Pub. No.: US 2008/0286154 A1
(43) Pub. Date: Nov. 20, 2008

(54) Multilayered optical sensing patch and retaining plug therefor

(75) Inventor: James A. Kane, Needham Heights, MA (US)

Correspondence Address: TOWNSEND & BANTA;c/o PORTFOLIO IP, PO BOX 52050, MINNEAPOLIS, MN, 55402, US

(73) Assignee: Polestar Technologies, Inc.

(21) Appl. No.: 11/803,901

(22) Filed: May 15, 2007

(51) Int. Cl. G01N 21/64; B05D 5/06; G01N 21/01

(52) U.S. Cl. 422/82.08; 422/82.05; 427/157

(57) ABSTRACT

A multilayered optical sensing patch, for the measurement of conditions, such as pH, oxygen level, etc, within containers, is provided. The multilayered optical sensing patch of the present invention is comprised of a heat sealable polymer substrate layer, and a polymeric sensing membrane later attached thereto. The polymer sensing membrane layer is formed of a porous polymer support membrane, and an optical sensing composition immobilized on or within the porous polymer substrate membrane. The heat sealable polymer substrate layer is capable of being securely bonded to the inner layer of bioreactor bags, as well as the porous polymer support substrate layer. Further, the porous polymer support membrane layer provides a firm supporting structure for the polymeric sensing layer, thereby protecting the optical sensing composition disposed therein from degradation/damage.

### FIELD OF THE INVENTION

The present invention provides a multilayered optical sensing patch, for the measurement of conditions, such as pH, oxygen level, etc, within containers, as well as a retaining plug for securing same to a container of interest. In particular, a multilayered optical sensing patch is provided, having a heat sealable polymer substrate layer, and a polymeric sensing membrane attached to the heat sealable polymer substrate layer, the polymeric sensing membrane comprised of a porous polymer support membrane having optical sensing composition interpenetrated therein. And, a retaining plug, capable of retaining the optical sensing patch in contact with a solution to be measured, and of being heat welded to a container, is provided.

### BACKGROUND OF THE INVENTION

Optical sensing patches have conventionally been provided for the detection/measurement of oxygen, carbon dioxide and pH. Multilayered oxygen and pH sensing patches are currently sold which, for example, have either a glass or polyester substrate film, upon which is deposited a layer of silicone rubber impregnated with a fluorescent indicator that undergoes oxygen dependent quenching resulting in a reduction in the fluorescence lifetime and emission intensity. Conventional pH sensing patches also use polyester substrates, on which is deposited a hydrogel layer containing a fluorescent pH sensitive indicator.

Some conventional patches are affixed to the inner wall of the container of interest by use of an adhesive that is applied to the patch substrate by the end user. Other conventional oxygen and pH sensing patches have a multilayer design, with a polyester substrate. However, these patches are supplied with an adhesive layer in a peel and stick type format.

Most conventional optical sensing patches disadvantageously require adhesives to attach the sensing film. This use of adhesives creates the potential for delamination when used with polyolefin surfaces (e.g., polypropylene and polyethylene), such as are commonly used as the inner layer of disposable bag-type bioreactors. The polyolefin inner layers of these disposable bag-type bioreactors are important because they impart high biocompatibility and an ability to use heat sealing in the construction of the bag. Further, polyolefins are considered low energy surfaces which lack chemical functional groups that might normally be used to covalently couple with an adhesive layer. For these reasons, cyanoacrylate, epoxy, polyurethane, silicone, and most acrylic adhesives do not stick to polyolefins.

Conventional optical sensing patches, which utilize direct deposition of the pH sensing hydrogel layer onto a polyester substrate film, are also easily damaged. In particular, while the polyester substrate does provide the hydrogels with a degree of mechanical support, it fails to protect against damage due to handling or abrasives in the solutions to be monitored.

In view of the above-described disadvantages encountered with conventional optical sensing patches, it is an object of the present invention to provide an optical sensing patch capable of effectively bonding to the inner layer of bag bioreactors.

It is a further object of the present invention to provide an optical sensing patch which is durable and resistant to damage. In particular, it is an object of the present invention to provide an optical sensing patch which provides significantly enhanced protection against damage to the sensing composite, by providing a robust scaffold upon which the sensing composite can be deployed.

### SUMMARY OF THE INVENTION

In order to achieve the above mentioned objects of the present invention, the present inventor earnestly endeavored to provide an multilayered optical sensing patch capable of being bonded to the inner layer of bioreactor bags, while also being capable of securing, in a protective manner, the optical sensing composition of interest. Accordingly, in a first embodiment of the present invention, a multilayered optical sensing patch is provided, comprising:

(a) a heat sealable polymer substrate layer; and

(b) a polymeric sensing membrane layer attached to said heat sealable polymer substrate layer, said polymeric sensing membrane layer comprised of:
(i) a porous polymer support membrane layer having a plurality of pores disposed therein; and
(ii) an optical sensing composition immobilized within the porous polymer support membrane layer.

In a second embodiment of the present invention, the multilayered optical sensing patch of the first embodiment above is provided, wherein the heat sealable polymer substrate layer is comprised of one or more of a polyether, polyamide, or polyolefin.

In a third embodiment of the present invention, the multilayered optical sensing patch of the first embodiment above is provided, wherein the heat sealable polymer substrate has an optical transparency of 50% or greater over the spectral range of interest.

In a fourth embodiment of the present invention, the multilayered optical sensing patch of the first embodiment above is provided, wherein the porous polymer support membrane is comprised of nylon, polyethersulfone, polyetheretherketone, polyester, polycarbonate, cellulous acetate, nitrocellulous, polyvinylidene fluoride, or polytetrafluoroethylene.

In a fifth embodiment of the present invention, the multilayered optical sensing patch of the first embodiment above is provided, wherein the porous polymer support membrane has a pore size of from about 0.1 to about 20 μm.

In a sixth embodiment of the present invention, the multilayered optical sensing patch of the first embodiment above is provided, wherein the porous polymer support membrane has an onset melt temperature of 200 degrees centigrade or greater.

In a seventh embodiment of the present invention, the multilayered optical sensing patch of the first embodiment above is provided, wherein the porous polymer support membrane is attached to the heat sealable polymer membrane at an interpenetrating interfacial region, said interfacial region being formed by percolation of the heat sealable polymer membrane into the pores of the porous polymer support membrane during heating.

In an eighth embodiment of the present invention, the multilayered optical sensing patch of the first embodiment above is provided, wherein the optical sensing composition is deposited within the pores of the porous polymer support membrane.

In a ninth embodiment of the present invention, the multilayered optical sensing patch of the first embodiment above is provided, wherein the optical sensing composition is deposited within pores of the porous polymer support membrane by one or more of solution casting, in situ polymerization, and chemical modification of the surface of the pores of the porous polymer support membrane.

In a tenth embodiment of the present invention, the multilayered optical sensing patch of the first embodiment above is provided, wherein the optical sensing composition is immobilized within the polymeric sensing membrane by encapsulation, covalent linkage, or a combination of electrostatic and dispersive force interactions.

In an eleventh embodiment of the present invention, the multilayered optical sensing patch of the first embodiment above is provided, wherein the optical sensing composition is deposited as a coating on the porous polymer support membrane, so as to partially or wholly fill the pores of the porous polymer support membrane.

In a twelfth embodiment of the present invention, the multilayered optical sensing patch of the first embodiment above is provided, wherein the optical sensing composition is a fluorescent or calorimetric sensing composition for the detection or measurement of oxygen, pH, carbon dioxide, ammonia, alkali and alkaline-earth metal ions, nutrients such as glucose, or metabolites such as lactate, acetate.

In a thirteenth embodiment of the present invention, the multilayered optical sensing patch of the first embodiment above is provided, wherein the optical sensing composition comprises one or more fluorescent or colorimetric indicator chemistries electrostatically coupled to a quaternary ammonium modified film of poly(vinylbenzylchloride), said polymer sensing membrane.

In a fourteenth embodiment of the present invention, the multilayered optical sensing patch of the first embodiment above is provided, wherein the heat sealable polymer substrate is polyethylene, the porous polymer support membrane is a microporous nylon, and the optical sensing composition is comprised of particles, said particles being dispersed within the pores of the microporous nylon.

In a fifteenth embodiment of the present invention, a method of manufacturing the multilayered optical sensing patch of the first embodiment above is provided, comprising the steps of:

laminating a heat sealable polymer substrate film with a porous polymer support membrane film, said porous polymer support membrane film having pores;

coating the pores of the porous polymer support membrane film using a solution comprising an optical sensing composition, the optical sensing composition comprising an organic soluble polymer incorporating bound fluorescent and/or colorimetric indicator groups;

removing the solvent from the solution comprising an organic soluble polymer incorporating bound fluorescent and/or colorimetric indicator groups, so as to form a sensing layer comprising the optical sensing composition on the porous polymer support membrane film;

activating the sensing layer for indicator binding by chemical generation of indicator binding sites such as quaternary ammonium chloride groups.

immobilizing the indicator within in the activated sensing layer by soaking in a solution of the indicator for sufficient period of time to allow reaction between the indicator and the activated binding site; and removing any unbound indicator from the sensing layer by prolonged soaking in aqueous solution.

In a sixteenth embodiment of the present invention, a method of manufacturing the multilayered optical sensing patch of the first embodiment above is provided, comprising the steps of:

laminating a heat sealable polymer substrate film to a porous polymer support membrane layer, having pores therein, using a combination of heat and pressure;

coating the pores of the laminated porous polymer support membrane layer by dipping said layer into a solution of polymeric material possessing covalently attached or copolymerized fluorescent or colorimetric indicator groups in an organic solvent; and

removing the organic solvent from the pores of the laminated porous polymer support layer by evaporation or washing the laminated porous polymer support layer with distilled water;

activating the polyvinylbenzylchloride (by converting the benzylchloride groups to cationic quaternary ammonium chloride groups) coated on the pores of the porous polymer support membrane layer by reacting the polyvinylbenzylchloride with a solution of trimethylamine in pH 9.0 phosphate buffer for 2 days at 60 degrees centigrade, followed by washing the porous polymer support membrane layer with distilled water, so as to form a sensing layer; and

immobilizing the polyinylbenzylchloride in the activated sensing layer polymer by soaking the sensing layer in a buffered solution of anionic indicator.

In a seventeenth embodiment of the present invention, the method of manufacturing the multilayered optical sensing patch of the sixteenth embodiment above is provided, wherein the polymeric material possessing the covalently attached indicator groups comprises a hydrophilic polymer.

In an eighteenth embodiment of the present invention, the method of manufacturing the multilayered optical sensing patch of the seventeenth embodiment above is provided, wherein the hydrophilic polymer is comprised of poly(hydroxyethylmethacylate), poly(hydroxypropylmethacylate), poly(hydroxyethylacylate), polyacrylamide, polymethacrylamide, polyvinyl alcohol, polyvinylpyrrolidone, polystyrene sulfonate, poly(acrylic acid), poly(2-acrylamido-2-methylpropane sulfonic acid), hydroxypropyl cellulose, or hydroxyethyl cellulose.

In a nineteenth embodiment of the present invention, the method of manufacturing the multilayered optical sensing patch of the sixteenth embodiment above is provided, wherein the organic solvent comprises one or more of ethanol, methanol, propanol, dimethylformamide, dimethylacetamide, acetone, methyl cellosolve, methyl ethyl ketone, dichloromethane, tetrahydrofuran, or ethylacetate.

In a twentieth embodiment of the present invention, an optical sensing patch retaining plug is provided comprising:

a plug body having a plug face;

an optical sensing patch in communication with the plug face; and

a fiber optic insertion channel disposed within said plug body, said fiber optic insertion channel being disposed adjacent to the optical sensing patch,

wherein at least a portion of the plug face not in communication with the optical sensing patch may be welded to a bioreactor bag or other container of interest.

In a twenty first embodiment of the present invention, the optical sensing patch retaining plug of the twentieth embodiment above is provided, wherein the optical sensing patch comprises:

a heat sealable polymer substrate layer;

a porous polymer support membrane layer having a plurality of pores disposed therein, said porous polymer support membrane being attached to said heat sealable polymer substrate; and

a polymeric sensing membrane layer comprising an optical sensing composition, the polymeric sensing membrane being immobilized within the porous polymer support membrane.

In a twenty second embodiment of the present invention, the optical sensing patch retaining plug of the twentieth embodiment is provided, wherein the plug body is comprised of heat sealable material.

In a twenty third embodiment of the present invention, the optical sensing patch retaining plug of the twenty first embodiment is provided, wherein the heat sealable material is comprised of one or more of polypropylene, low density polyethylene, linear low density polyethylene, ethyl vinyl acetate, hydrolyzed ethylene vinyl acetate, low vinyl acetate ethylene-vinyl acetate copolymer, polyvinylidene fluoride, styrene butasiene copolymers, ionomers, acid copolymers, thermoplastic elastomers, and plastomers.

In a twenty fourth embodiment of the present invention, the optical sensing patch retaining plug of the twentieth embodiment is provided, wherein the fiber optic insertion channel comprises a means for securedly retaining a fiber optic device therein.

In a twenty fifth embodiment of the present invention, the optical sensing patch retaining plug of the twenty fourth embodiment is provided, wherein the means for securedly retaining a fiber optic device comprises threaded members, compression fit retaining devices and/or adhesives.

### BRIEF DESCRIPTION OF THE DRAWINGS

FIG. 1 is a cross sectional view of the multilayered optical sensing patch of the present invention.

FIG. 2 is a cross sectional view of the optical sensing patch retaining plug of the present invention, having the multilayered optical sensing patch of the present invention attached thereto, which is capable of retaining a fiber optic device adjacent to the optical sensing patch.

### DETAILED DESCRIPTION OF THE INVENTION

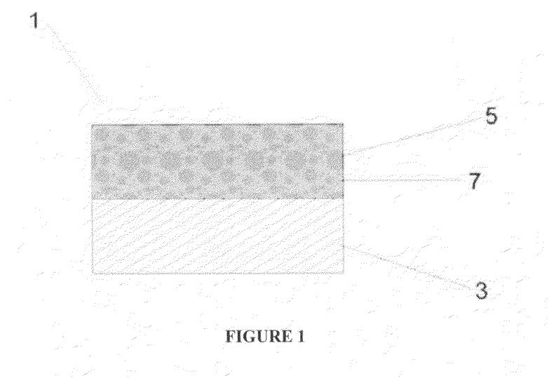

The present invention provides multilayered optical sensing patches having three basic polymeric layers. In particular, as illustrated in FIG. 1, the multilayered optical sensing patch 1 of the present invention includes a heat sealable layer 3, and a polymeric sensing membrane 5 attached to the heat sealable layer 3. The polymeric sensing membrane 5 is formed of a porous polymer support membrane layer having one or more optical sensing compositions interpenetrated therein, and coating the pores thereof. The heat sealable layer 3 allows the optical sensing patch of the present invention to be securely adhered to the inner layer of bioreactor containers/bags.

Further, the polymeric sensing membrane layer 5 of the present invention significantly enhances protection against damage to the optical sensing composition (contained/coated within the polymeric sensing membrane layer 7) by providing a robust scaffold upon which the optical sensing composition can be deployed. Specifically, depositing the optical sensing composition within the pores of the polymeric sensing membrane 5 moves the more fragile optical sensing composition(s) away from the surface where abrasive contact can occur.

The heat sealable layer 3 may be comprised of a polyether, polyamide, or polyolefin. The heat sealable layer 3 should have good optical transparency, to allow for optical measurement therethrough. In particular, an optical transparency of 50% or greater over the spectral range of interest is preferred. Further, the heat sealable layer 1 should have a low processing temperature, to enable it to heat seal with the porous polymer support membrane of the polymeric sensing membrane layer 5 without damaging the support membrane layer. In particular, a processing temperature of 180 degrees centigrade or less is preferred.

The polymeric sensing membrane layer 5 is heat sealed to the heat sealable layer 3. In particular, the heat sealable layer 3 is disposed adjacent the polymeric sensing membrane layer 5, and both layers are heated to a temperature higher than the onset melting point of the heat sealable layer 3, but lower than the melt temperature of the polymeric sensing membrane layer 5. During heating, a portion of the molten heat sealable layer 3 percolates into the porous polymer support layer of the polymeric sensing membrane layer 5 such that, upon cooling, a strong mechanical bond is formed between the two layers. The porous polymer support membrane may be comprised of nylon, polyethersulfone, polyetheretherketone, polyester, polycarbonate, cellulous acetate, nitrocellulous, polyvinylidene fluoride, or polytetrafluoroethylene.

In a preferred embodiment, the porous polymer support membrane is comprised of nylon or polyethersulfone. The porous polymer support membrane has a plurality of pores formed therein, each pore preferredly having a pore size of between about 0.1 and about 20 μm, so as to be capable of allowing the polymeric sensing membrane layer 7 to be immobilized therein.

Further, as described above, the porous polymer support membrane layer of the polymeric sensing layer 5 should have a high melt and/or decomposition temperature. In particular, it is preferred that the melt temperature of the porous polymer support membrane be higher than that of the heat sealable layer 3, so as to allow the porous polymer support membrane to withstand the heat sealing process described above. It is preferred that the porous polymer support membrane have an onset melt temperature of 200 degrees centrigrade or greater.

In an alternative embodiment, the porous polymer support membrane of the polymeric sensing membrane layer 5 is formed of woven plastics (i.e., nylon, polypropylene, etc.), or metals (i.e., stainless steel, copper, etc.). In such an alternative embodiment, such support structure could be used in place of the macro-porous polymer support membrane layer described above.

The polymeric sensing membrane layer 5 is a vehicle for immobilizing the indicator chemistry (i.e., the optical sensing composition) used for sensing. Techniques for immobilizing the indicator (optical sensing composition) within the polymeric sensing membrane layer 5 include encapsulation, covalent linkage, or a combination of electrostatic and dispersive force interactions. The polymeric sensing membrane layer 5 may be hydrophobic or hydrophilic, depending on the parameter that is being sensed (e.g., hydrophobic for oxygen, hydrophilic for pH).

The polymeric sensing membrane layer 5 contains one or more optical sensing compositions, applied to the surface of the pore structure of the porous polymer support membrane layer 5, so as to interpenetrate the polymeric sensing membrane layer 5, thereby binding the sensing composite membrane. This polymeric sensing membrane layer 5 is attached to the heat sealable layer 3 by the formation of an interpenetrating interfacial region, formed by percolation of the heat sealable material 3 into the polymeric sensing membrane layer 5 during heating.

The optical sensing composition may be coated/disposed within the pore structure of the porous polymer support membrane by the use of solution casting, in situ polymerization, chemical modification of the pore surface, or a combination of one or more of these techniques. Alternatively, the optical sensing composition may be deposited within the porous polymer support membrane layer as a coating that partially or fully fills the porous polymer support membrane, or can be provided in the form of finely divided particles that are dispersed within the pores of the porous polymer support membrane. The present inventor has constructed optical sensing patches using both pore coatings and particles, and has found both to function well.

Examples of porous membranes used to construct the multilayered optical sensing patches of the present invention include those from GE OSMONICS®. Methods of immobilizing the indicator within the polymeric sensing membrane layer 5 include encapsulation, covalent linkage, or a combination of electrostatic and dispersive force interactions.

Experiments conducted by the present inventor have shown that the optical sensing composition can be deposited into the pores of the porous polymer support membrane layer before or after heat sealing thereof with the polyolefin comprising the heat sealable layer 3. Thus, it has been unexpectedly discovered that the polymeric sensing membrane layer 5, containing the optical sensing composition, can be heat sealed directly to the films used to construct bag-type bioreactors, or via a polyolefin layer heat sealed prior to coupling with bag films. It has been found that each approach yields a strong mechanical bond between the sensing film and the bag film.

In an alternative embodiment of the present invention, a multilayered fluorescence sensing film is provided, which combines a porous sensing layer support element and a transparent substrate layer, using a thin layer of adhesive, rather than heat sealing, to bond the two films together. In particular, sensing films have been made with both stainless steel and nylon mesh. However, woven mesh tends to yield sensing layers that are thicker than what are possible with the macro-porous membranes described above, which results in longer response times. The woven mesh also fails to provide as much protection against abrasive damage to the polymeric sensing membrane layer as the porous polymer substrate membrane layer described above.

In order to retain the optical sensing patch of the present invention, as described above, securely against a bioreactor bag or other container of interest, the present inventor has developed an optical sensing patch retaining plug. In particular, this optical sensing patch retaining plug allows the optical sensing patch of the present invention to come into contact with the solution of interest, via a hole formed in the wall of the bioreactor bag or container of interest, to which the retaining plug is securedly attached. The retaining plug is heat welded to the bioreactor bag or container of interest around the periphery of the plug face, thereby allowing the optical sensing patch to come into direct contact with the contents of the bioreactor bag, while simultaneously allowing the optical sensing patch to be illuminated by a fiber optic device, emissions thereof measured, and provide an airtight seal.

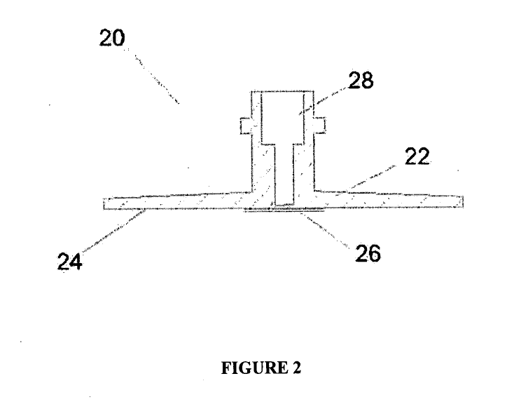

Specifically, as illustrated in FIG. 2, an optical sensing patch retaining plug 20 is provided, comprised of a plug body 22. The plug body 22 has a plug face 24 formed continuously therewith. In a preferred embodiment, the plug body 22 is comprised of heat sealable material, enabling heat welding thereof to a bioreactor bag or other container with which an optical sensing patch may be used. Most preferredly, the plug body 22 is comprised of one or more of polypropylene, low density polyethylene, linear low density polyethylene, ethyl vinyl acetate, hydrolyzed ethylene vinyl acetate, low vinyl acetate ethylene-vinyl acetate copolymer, polyvinylidene fluoride, styrene butadiene copolymers, ionomers, acid copolymers, thermoplastic elastomers, and plastomers. These material are capable of formed a strong weld to other heat sealable materials, which bioreactors bags, etc., are usually formed of.

An optical sensing patch 26 is disposed adjacent the plug face 24. The optical sensing patch retaining may be a conventional optical sensing patch. Preferredly, the optical sensing patch 26 is the optical sensing patch of the present invention as described above.

Disposed within the plug body 22 is a fiber optic insertion channel 28. The fiber optic insertion channel 28 is defined by the material comprising the plug body 22. Importantly, the fiber optic insertion channel 28 is disposed within the plug body 22 adjacent to the area on the plug body 22 where the optical sensing patch 26 is attached/disposed adjacent to, so that the fiber optic may emit light upon the optical sensing patch 26. This may be achieved by forming the fiber optic insertion channel 28 completely through the plug body 22.

However, preferredly, a small wall of material forming the plug body 22 is disposed between the fiber optic insertion channel 28 and the area on the plug body 22 where the optical sensing patch 26 is attached/disposed adjacent to. In such a preferred embodiment, the plug body 22 is formed of a material having an optical transparency sufficient to allow the fiber optic device (not illustrated) disposed within the fiber optic insertion channel 28 to adequately illuminate the optical sensing patch 26

The fiber optic insertion channel 28 comprises a means for securedly retaining a fiber optic device therein. For example, threaded members may be formed in the material defining the fiber optic channel 28, so as to allow a fiber optic device to be screwed therein. Or, a compression fit retaining device may be disposed within the channel 28, so as to allow the fiber optic device to be securedly held within the channel 28. Alternatively, the geometry of the channel 28 may be configured so as to provide a secure fit for the fiber optic device, or the fiber optic device may be secured within the channel 28 using one or more adhesive compositions.

### Methods of Manufacture of the Optical Sensing Patch:

In addition to a multilayered optical sensing patch, the present invention provides a method of manufacturing the multilayered optical sensing patch of the present invention. In particular, the method of the present invention includes, a first step is provided involving laminating a heat sealable polymer substrate film with a porous polymer support membrane film having pores therein. This is performed using a combination of heat and pressure.

The second step of the method of manufacture involves coating the pores of the porous polymer support membrane film using a solution comprising an optical sensing composition comprised of an organic soluble polymer incorporating bound fluorescent and/or calorimetric indicator groups. This coating process may comprise dipping the laminated porous polymer support membrane layer into a solution of polymeric material possessing covalently attached or copolymerized fluorescent or colorimetric indicator groups in an organic solvent. The organic solvent comprises one or more of ethanol, methanol, propanol, dimethylformamide, dimethylacetamide, acetone, methyl cellosolve, methyl ethyl ketone, dichloromethane, tetrahydrofuran, or ethylacetate

The polymeric material possessing the covalently attached indicator groups comprises a hydrophilic polymer. For example, the polymeric material may be poly(hydroxyethylmethacylate), poly(hydroxypropylmethacylate), poly(hydroxyethylacylate), polyacrylamide, polymethacrylamide, polyvinyl alcohol, polyvinylpyrrolidone, polystyrene sulfonate, poly(acrylic acid), poly(2-acrylamido-2-methylpropane sulfonic acid), hydroxypropyl cellulose, or hydroxyethyl cellulose.

In a third step, the solvent is removed from the solution comprising an organic soluble polymer incorporating bound fluorescent and/or colorimetric indicator groups. This is performed in any effective manner, such as evaporation, washing the laminated porous polymer support layer with distilled water, etc. By removing the solvent, a sensing layer, comprised of the optical sensing composition, is formed on the porous polymer support membrane. Then, in a fourth step, the sensing layer is activated, by chemical generation of indicator binding sites such as quaternary ammonium chloride groups.

In a fifth step of the method of the present invention, the indicator, i.e., the optical sensing composition, is immobilized within the activated sensing layer by soaking the sensing layer in a solution of the indicator for a sufficient period of time to allow reaction between the indicator and the activated binding site. Although the soaking time depends upon indicator used, generally, the activated sensing layer is soaked for a period of from about one to ten minutes depending on the concentration of the indicator solution.

Finally, in a sixth step, any unbound indicator is removed from the sensing layer by prolonged soaking of the sensing layer in distilled water or aqueous buffer solutions.

In a preferred embodiment of the above-described method of manufacturing the multilayered optical sensing patch of the present invention, the following steps are provided:

(1) Laminating a heat sealable polymer substrate film to the porous polymer support membrane layer as described above using a combination of heat and pressure.

(2) Coating the pores of the laminated porous polymer support membrane layer by dipping same into a solution of polymeric material possessing covalently attached or copolymerized fluorescent or calorimetric indicator groups, as described above, in an organic solvent, as described above.

(3) Removing the organic solvent from the pores of the laminated porous polymer support layer by evaporation or washing of the laminated porous polymer support layer with distilled water.

(4) Activating polyvinylbenzylchloride (by converting the benzylchloride groups to cationic quaternary ammonium chloride groups) coated on the pores of the porous polymer support membrane layer by reacting the polyvinylbenzylchloride with a solution of trimethylamine in pH 9.0 phosphate buffer for 2 days at 60 degrees centigrade, followed by washing the porous polymer support membrane layer with distilled water, so as to form an activated sensing layer; and

(5) Immobilizing the polyinylbenzylchloride in the activated sensing layer polymer by soaking the activated sensing layer in a buffered solution of anionic indicator.

Representative examples of the methods described above are provided below as follows:

### EXAMPLE 1

A polymer pH sensing membrane layer coating was produced by electrostatically coupling 8-hydroxypyrene-1,3,6-trisulfonic acid (a pH indicator) to a quaternary ammonium modified film of poly(vinylbenzylchloride). This polymer pH sensing membrane layer was then deposited in the pores of a porous nylon substrate polymer, to produce a multilayered optical sensing patch.

In particular, a thin film of the polymer pH sensing membrane layer described above was formed on a GE OSMONICS® nylon membrane by first soaking the nylon membrane in solutions of poly(vinylbenzylchloride) and triethylamine in dimethylformamide. Then, the dimethylformamide was removed by washing the nylon membrane with water. The nylon film was then soaked for 2 days in a buffered solution containing a tertiary amine such as trimethylamine, to convert the benzylchloride groups of the poly(vinylbenzylchloride) polymer to quaternary ammonium sites.

Once the quaternary ammonium groups were formed, the nylon membrane was then soaked in a solution of 8-hydroxypyrene-1,3,6-trisulfonic acid (an anionic pH indicator), with coupling of the indicator occurring as a result of interactions between the cationic ammonium groups of the pore coating and the anionic sulfonic acid groups of the pH sensitive fluorescent dye. The resulting pH sensing membrane film was then used to measure solution pH by optically measuring the ratio of fluorescent emission intensities at 520 nm when illuminating the film with 390 nm and 460 nm excitation light.

### EXAMPLE 2

A polymer pH sensing membrane layer consisting of finely ground particles was formed using a strong anionic exchange DOWEX® resin. DOWEX® anion exchange resins consist of cross-linked polymer matrices synthesized from styrene and divinylbenzene then chemically modified to incorporate trimethylammonium chloride sites. A pH sensing resin was formed by mixing the DOWEX® anion exchange resin in an aqueous solution of 8-hydroxypyrene-1,3,6-trisulfonic acid (an anionic pH indicator), to allow coupling of the indicator to the cationic sites within the resin. The indicator/resin was then reduced to a finely ground powder by drying, then grinding using a WIGGLE BUG® grinder.

The finely ground indicator/resin particles were loaded into the pores of the support polymer by filtering aqueous suspends of the particles through films of the support polymer. The particles are retained in the pore structure by virtue of the particle size and the tortuous path created by the interconnecting pores. The resulting pH sensing membrane film was then used to measure solution pH by optically measuring the ratio of fluorescent emission intensities at 520 nm when illuminating the film with 390 nm and 460 nm excitation light.

### EXAMPLE 3

A fluorescent pH sensing membrane film was produced using a macro-porous nylon membrane (GE OSMONICS®, MAGNA®) having a pore size in the range of from 0.1 to 20 μm. A film of poly(vinylbenzyl trimethyl ammonium chloride) was formed within the porous structure of the nylon membrane by dip coating the membrane with a solution of poly(vinylbenzyl chloride), followed by reaction of the benzyl chloride groups with trimethyl amine.

The nylon/poly(vinyl benzyl trimethyl ammonium chloride) film was then heat sealed to a film of 3M® 1526 medical tape, then exposed to an aqueous solution of the 8-hydroypyrene-1,3,6-trisulfonic acid, which binds to the quaternary groups of the pore-coating polymer via electrostatic interactions between the polymer's cationic quaternary ammonia groups and the anionic sulfonic acid groups of the indicator. The resulting pH sensing membrane film was then used to measure solution pH by optically measuring the ratio of fluorescent emission intensities at 520 nm when illuminating the film with 390 nm and 460 nm excitation light.

### EXAMPLE 4

A fluorescent oxygen sensing film was produced by first heat sealing a GE OSMONICS® macro-porous nylon membrane to a film of low density polyethylene. Then, the exposed surface of the GE OSMONICS® porous nylon membrane was coated with a thin film of transparent silicone rubber by spreading a bead of GE® RTV118 silicone on the exposed surface using a doctor blade. The silicone rubber was then cured in air, and a silicone coated nylon film was produced.

Subsequently, the silicone coated nylon film was submerged in a solution of tris(4,7-diphenyl-1,10-phenanthroline) ruthenium (II) chloride in dichloromethane (an oxygen indicator solution), to enable diffusion of the oxygen-sensitive ruthenium complex into the silicone rubber. The silicone coated nylon film was then removed from the indicator solution, and the dichloromethane slowly evaporated, leaving the ruthenium complex embedded in the silicone rubber. Oxygen partial pressures in the vicinity of the film were then determined from measurements of the fluorescence lifetime or fluorescence emission intensity of the ruthenium complex embedded in the silicone layer of the film.

### EXAMPLE 5

A fluorescent pH sensing films was produced a GE OSMONICS® macro-porous polyethersulfone membrane (GE Osmonics) having a pore size in the range of 0.1 to 20 microns. The polyethersulfone membrane was heat sealed to a film of 3M® 1526 medical tape to form a laminate of the two films. A solution of a pH sensing hydrogel polymer dissolved in methanol was then cast onto the polyethersulfone side of the laminate, and the methanol evaporated to leave a film of the pH sensing polymer within the pores of the polyethersulfone portion of the membrane laminate.

The polymeric pH sensing membrane file was then formed by copolymerizing N-fluoresceinyl-acrylamide and 2-hydroxyethyl methacrylate. The resulting pH sensing film (optical sensing film) was then used to measure solution pH from the ratio of emission signal intensities observed at 530 nm during photoexcitation of the sensing film with at 437 nm and 490 nm.

### EXAMPLE 6

A colorimetric pH sensing membrane film was produced using a macro-porous nylon membrane (GE OSMONICS®, MAGNA®) having a pore size in the range of from 0.1 to 20 μm. A film of poly(vinylbenzyl trimethyl ammonium chloride) was formed within the porous structure of the nylon membrane by dip coating the membrane with a solution of poly(vinylbenzyl chloride), followed by reaction of the benzyl chloride groups with trimethyl amine.

The nylon/poly(vinyl benzyl trimethyl ammonium chloride) film was then heat sealed to a film of 3M® 1526 medical tape, then exposed to an aqueous solution of bromothymolsulfophthalein sodium salt, which binds to the quaternary groups of the pore-coating polymer via electrostatic interactions between the polymer's cationic quaternary ammonia groups and the anionic sulfonic acid group of the indicator. The bound pH sensitive indicator dye exhibited strong pH sensitive shift in its absorption spectra allowing the resulting pH sensing membrane film to be used to measure solution pH by optically measuring the ratio of scattered light intensities at 620 nm and 460 nm when illuminating the film with either a broadband white light source such as an incandescent light or a pair of light emitting diodes having emission maxima of 620 nm and 460 nm.

### EXAMPLE 7

A calorimetric pH sensing membrane film was produced using a macro-porous nylon membrane (GE OSMONICS®, MAGNA®) having a pore size in the range of from 0.1 to 20 μm. The nylon membrane was heat sealed to a film of 3M® 1526 medical tape to form a laminate of the two films. A solution of a pH sensing hydrogel polymer dissolved in methanol was then cast onto the nylon side of the laminate, and the methanol evaporated to leave a film of the pH sensing polymer within the pores of the polyethersulfone portion of the membrane laminate.

The polymeric pH sensing membrane file was then formed by copolymerizing N-bromophenol phthalein-acrylamide and 2-hydroxyethyl methacrylate. The resulting pH sensing film (optical sensing film) was then used to measure solution pH from the ratio scattered light intensities at 620 nm and 460 nm when illuminating the film with either a broadband white light source such as an incandescent light or a pair of light emitting diodes having emission maxima of 620 nm and 460 nm.

Although specific embodiments of the present invention have been disclosed herein, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

What is claimed is:

1. A multilayered optical sensing patch comprising:
(a) a heat sealable polymer substrate layer; and
(b) a polymeric sensing membrane layer attached to said heat sealable polymer substrate layer, said polymeric sensing membrane layer comprised of:
(i) a porous polymer support membrane layer having a plurality of pores disposed therein; and
(ii) an optical sensing composition immobilized within the porous polymer support membrane layer.

2. The multilayered optical sensing patch of claim 1, wherein the heat sealable polymer substrate layer is comprised of one or more of a polyether, polyamide, or polyolefin.

3. The multilayered optical sensing patch of claim 1, wherein the heat sealable polymer substrate has an optical transparency of 50% or greater over the spectral range of interest.

4. The multilayered optical sensing patch of claim 1, wherein the porous polymer support membrane is comprised of nylon, polyethersulfone, polyetheretherketone, polyester, polycarbonate, cellulous acetate, nitrocellulous, polyvinylidene fluoride, or polytetrafluoroethylene.

5. The multilayered optical sensing patch of claim 1, wherein the porous polymer support membrane has a pore size of from about 0.1 to about 20 μm.

6. The multilayered optical sensing patch of claim 1, wherein the porous polymer support membrane has an onset melt temperature of 200 degrees centigrade or greater.

7. The multilayered optical sensing patch of claim 1, wherein the porous polymer support membrane is attached to the heat sealable polymer membrane at an interpenetrating interfacial region, said interfacial region being formed by percolation of the heat sealable polymer membrane into the pores of the porous polymer support membrane during heating.

8. The multilayered optical sensing patch of claim 1, wherein the optical sensing composition is deposited within the pores of the porous polymer support membrane.

9. The multilayered optical sensing patch of claim 1, wherein the optical sensing composition is deposited within pores of the porous polymer support membrane by one or more of solution casting, in situ polymerization, and chemical modification of the surface of the pores of the porous polymer support membrane.

10. The multilayered optical sensing patch of claim 1, wherein the optical sensing composition is immobilized within the polymeric sensing membrane by encapsulation, covalent linkage, or a combination of electrostatic and dispersive force interactions.

11. The multilayered optical sensing patch of claim 1, wherein the optical sensing composition is deposited as a coating on the porous polymer support membrane, so as to partially or wholly fill the pores of the porous polymer support membrane.

12. The multilayered optical sensing patch of claim 1, wherein the optical sensing composition is a fluorescent or calorimetric sensing composition for the detection or measurement of oxygen, pH, carbon dioxide, ammonia, alkali and alkaline-earth metal ions, nutrients such as glucose, or metabolites such as lactate, acetate.

13. The multilayered optical sensing patch of claim 1, wherein the optical sensing composition comprises one or more fluorescent or calorimetric indicator chemistries electrostatically coupled to a quaternary ammonium modified film of poly(vinylbenzylchloride), said polymer sensing membrane

14. The multilayered optical sensing patch of claim 1, wherein the heat sealable polymer substrate is polyethylene, the porous polymer support membrane is a microporous nylon, and the optical sensing composition is comprised of particles, said particles being dispersed within the pores of the microporous nylon.

15. A method of manufacturing the multilayered optical sensing patch of claim 1, comprising the steps of:
laminating a heat sealable polymer substrate film with a porous polymer support membrane film, said porous polymer support membrane film having pores;
coating the pores of the porous polymer support membrane film using a solution comprising an optical sensing composition, the optical sensing composition comprising an organic soluble polymer incorporating bound fluorescent and/or calorimetric indicator groups;
removing the solvent from the solution comprising an organic soluble polymer incorporating bound fluorescent and/or calorimetric indicator groups, so as to form a sensing layer comprising the optical sensing composition on the porous polymer support membrane film;
activating the sensing layer for indicator binding by chemical generation of indicator binding sites such as quaternary ammonium chloride groups,
immobilizing the indicator within in the activated sensing layer by soaking in a solution of the indicator for sufficient period of time to allow reaction between the indicator and the activated binding site.; and
removing any unbound indicator from the sensing layer by prolonged soaking in aqueous solution.

16. A method of manufacturing the multilayered optical sensing patch of claim 1, comprising the steps of:
laminating a heat sealable polymer substrate film to a porous polymer support membrane layer, having pores therein, using a combination of heat and pressure;
coating the pores of the laminated porous polymer support membrane layer by dipping said layer into a solution of polymeric material possessing covalently attached or copolymerized fluorescent or colorimetric indicator groups in an organic solvent; and
removing the organic solvent from the pores of the laminated porous polymer support layer by evaporation or washing the laminated porous polymer support layer with distilled water;
activating the polyvinylbenzylchloride (by converting the benzylchloride groups to cationic quaternary ammonium chloride groups) coated on the pores of the porous polymer support membrane layer by reacting the polyvinylbenzylchloride with a solution of trimethylamine in pH 9.0 phosphate buffer for 2 days at 60 degrees centigrade, followed by washing the porous polymer support membrane layer with distilled water, so as to form a sensing layer; and
immobilizing the polyinylbenzylchloride in the activated sensing layer polymer by soaking the sensing layer in a buffered solution of anionic indicator.

17. The method of manufacturing the multilayered optical sensing patch of claim 16, wherein the polymeric material possessing the covalently attached indicator groups comprises a hydrophilic polymer.

18. The method of manufacturing the multilayered optical sensing patch of claim 17, as poly(hydroxyethylmethacylate), poly(hydroxypropylmethacylate), poly(hydroxyethylacylate), polyacrylamide, polymethacrylamide, polyvinyl alcohol, polyvinylpyrrolidone, polystyrene sulfonate, poly(acrylic acid), poly(2-acrylamido-2-methylpropane sulfonic acid), hydroxypropyl cellulose, or hydroxyethyl cellulose.

19. The method of manufacturing the multilayered optical sensing patch of claim 16, wherein the organic solvent comprises one or more of ethanol, methanol, propanol, dimethylformamide, dimethylacetamide, acetone, methyl cellosolve, methyl ethyl ketone, dichloromethane, tetrahydrofuran, or ethylacetate.

20. An optical sensing patch retaining plug comprising:
a plug body having a plug face;
an optical sensing patch in communication with the plug face; and
a fiber optic insertion channel disposed within said plug body, said fiber optic insertion channel being disposed adjacent to the optical sensing patch,
wherein at least a portion of the plug face not in communication with the optical sensing patch may be welded to a bioreactor bag or other container of interest.

21. The optical sensing patch retaining plug of claim 20, wherein the optical sensing patch comprises:
a heat sealable polymer substrate layer;
a porous polymer support membrane layer having a plurality of pores disposed therein, said porous polymer support membrane being attached to said heat sealable polymer substrate; and
a polymeric sensing membrane layer comprising an optical sensing composition, the polymeric sensing membrane being immobilized within the porous polymer support membrane.

22. The optical sensing patch retaining plug of claim 20, wherein the plug body is comprised of heat sealable material.

23. The optical sensing patch retaining plug of claim 20, wherein the heat sealable material is comprised of one or more of polypropylene, low density polyethylene, linear low density polyethylene, ethyl vinyl acetate, hydrolyzed ethylene vinyl acetate, low vinyl acetate ethylene-vinyl acetate copolymer, polyvinylidene fluoride, styrene butasiene copolymers, ionomers, acid copolymers, thermoplastic elastomers, and plastomers.

24. The optical sensing patch retaining plug of claim 20, wherein the fiber optic insertion channel comprises a means for securedly retaining a fiber optic device therein.

25. The optical sensing patch retaining plug of claim 23, wherein the means for securedly retaining a fiber optic device comprises threaded members, compression fit retaining devices and/or adhesives.
